(19) United States
(12) Patent Application Publication
(10) Pub. No.: US 2002/0161453 A1
(43) Pub. Date: Oct. 31, 2002

(54) Collective memory network for parallel processing and method therefor

(76) Inventor: Michael G. Peltier, Oro Valley, AZ (US)

Correspondence Address: WEISS & MOY PC, 4204 NORTH BROWN AVENUE, SCOTTSDALE, AZ, 85251, US

(21) Appl. No.: 10/127,072

(22) Filed: Apr. 19, 2002

Related U.S. Application Data
(60) Provisional application No. 60/286,840, filed on Apr. 25, 2001.

(51) Int. Cl. G05B 19/18

(52) U.S. Cl. 700/5; 700/2

(57) ABSTRACT

A shared memory network means and method providing nearly instance sharing of data between a plurality of digital processing nodes, thereby allowing an arbitrarily large number of processing nodes to be connected into a single system such as a super computer, and further providing means for assimilation of legacy equipment into system whereby service life of obsolete equipment is extended.

### RELATED APPLICATIONS

This patent application is claiming the benefit of the U.S. Provisional Application having an application number of 60/286,840 filed Apr. 25, 2001, in the name of Michael G. Peltier, and entitled “COLLECTIVE MEMORY NETWORK FOR PARALLEL PROCESSING”.

### BACKGROUND OF THE INVENTION

1. Field of the Invention

This invention relates to multiple processors and multiple computers. Specifically, to provide a method and means for fast and efficient sharing of common data in a seamless fashion, thereby assimilating multiple processors and/or computers into a single super computer. Furthermore, the current invention provides a means to assimilate legacy processing equipment (i.e. outdated or obsolete equipment) seamlessly into the parallel processing super computer, thereby extending the useful operating life of legacy equipment and eliminating the need to discard such equipment during system upgrades. Also provided by the current invention is the necessary means to implement a hierarchical collective memory architecture for multiple processors (see Provisional Patent Application having Application No. 60/286,839, filed Apr. 25, 2001, entitled HIERARCHICAL COLLECTIVE MEMORY ARCHITECTURE FOR MULTIPLE PROCESSORS, and in the name of Michael G. Peltier).

2. Description of the Prior Art

As the use of Information Technologies (IT) has increased over the past years, so too has the need for more throughput from digital computers. Most modern solutions for demanding IT applications involve using Multiple Processors (MP), which generally communicate through shared memory, or multiple computers, which generally communicate over a network. These solutions increase throughput by parallel processing, in which one or more tasks are processed concurrently by a plurality of processing devices. While these solutions were satisfactory at one time, demands on IT services have revealed a number of bottlenecks regarding these solutions.

In the case where multiple processors are employed, a limitation was quickly realized regarding the bandwidth of the shared memory bus. That is, as the number of processors increase the demand on the shared memory bus also increase. This increase in demand results in longer latency times causing processors to wait for access to shared memory. Once the bandwidth on the shared memory bus is saturated, adding more processors only increases each processor's average wait time and no additional throughput is realized regardless of the number of processors added to the system.

In the case where parallel processing is accomplished over a network, each computer in the network has private memory, which is not shared. This eliminates the problem of congestion on a shared memory bus. In addition, a network will allow use of an arbitrarily large number of computers for parallel processing.

The disadvantage of network-based parallel processing is that information common to several computers must be physically transferred from one computer to the next, which reduces throughput and causes data coherency problems. Also, data transferred between computers on a network must typically be converted to and from a portable data format, which also reduces throughput. In practice, the benefits of using of individual computers on a network for parallel processing is generally limited to specific applications, where a common data set can be logically broken into discrete autonomous tasks and the amount of data required to be transferred is small with respect to the time required to process said data.

Therefore, a need existed to provide a method and means to overcome shared memory congestion and increase throughput. The method and means to overcome shared memory congestion and increase throughput will provide multiple data paths for shared memory using a distributed shared memory over a memory-based network, thereby providing both the benefits of shared memory techniques and the benefits of network-based parallel processing without the processing overhead typically associated with networks. In addition the current invention can be retrofitted to legacy equipment by configuring a memory network interface to be compatible with said legacy equipment's memory sockets or memory connection devices, thereby allowing obsolete equipment to realize a longer service life.

### SUMMARY OF THE INVENTION

In accordance with one embodiment of the present invention, it is an object of the present invention to provide a method and means to overcome shared memory congestion and increase throughput.

It is another object of the present invention to provide a method and means to overcome shared memory congestion and increase throughput by providing multiple data paths for shared memory using a distributed shared memory over a memory-based network, thereby providing both the benefits of shared memory techniques and the benefits of network-based parallel processing without the processing overhead typically associated with networks.

It is still another object of the present invention to provide a method and means to overcome shared memory congestion and increase throughput that can be retrofitted to legacy equipment by configuring a memory network interface to be compatible with said legacy equipment's memory sockets or memory connection devices, thereby allowing obsolete equipment to realize a longer service life.

### BRIEF DESCRIPTION OF THE EMBODIMENTS

In accordance with one embodiment of the present invention a shared memory network system for nearly instance sharing of data comprising is disclosed. The shared memory network system comprises a plurality of digital processing nodes wherein each of the digital processing nodes may access internal memory within the digital processing node or memory elsewhere within the memory network system. Each of the plurality of digital processing nodes comprises a processor which provides memory request signals and memory configuration signals. A memory configuration bus is coupled to the processor to access memory configuration data. A local memory bus is coupled to the processor. A plurality of memory connection devices is coupled to the memory configuration bus and the local memory bus. A memory module is coupled to at least one of the plurality of memory connection devices. A memory network interface is coupled to at least one of the plurality of memory connection devices. A memory network hub is coupled to the memory network interface.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a simplified block diagram of a plurality of processing nodes.

FIG. 2 is a simplified block diagram if a memory network interface.

FIG. 3 is another embodiment of the memory network interface.

### DETAILED DESCRIPTION OF THE PREFERRED EMBODIMENT

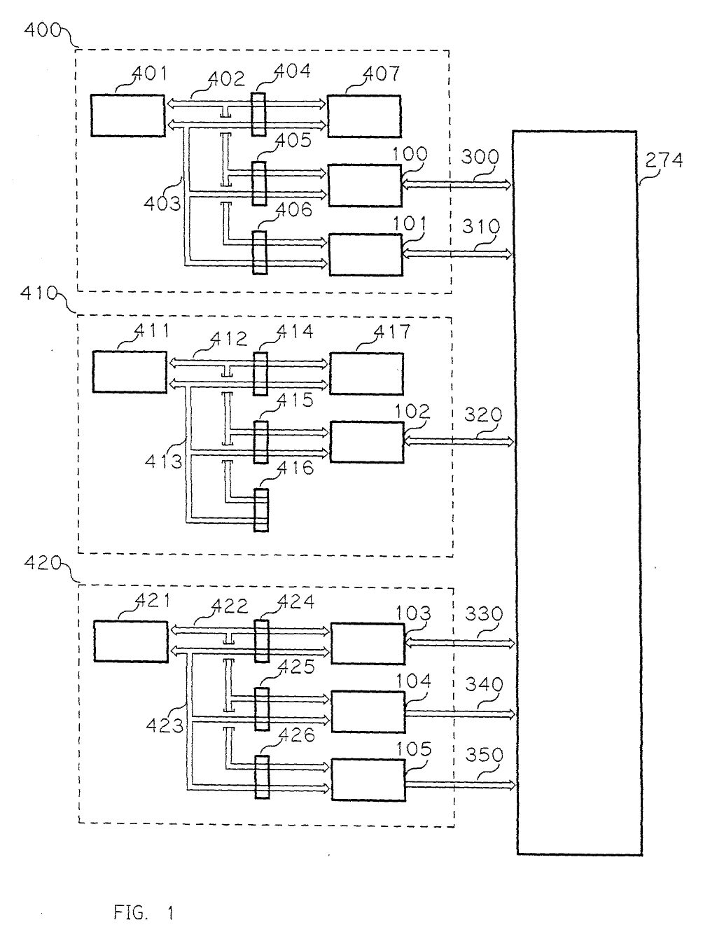

Refer to FIG. 1, illustrated are three digital processing nodes (400, 410, and 420), which are similar to one another though not identical. Note that any number of digital processing nodes can be used, whether identical to one another or not, and can include legacy equipment adapted for use by the current invention. The showing of three processing nodes should not be seen as to limit the scope of the present invention.

Digital processing node 400 comprises a processing unit 401 connected to a memory configuration bus 402, which is typically an ICC serial bus used to access memory configuration information, and a local memory bus 403. Memory configuration bus 402 and local memory bus 403 are connected to memory connection devices 404, 405, and 406.

This configuration (401 through 406 inclusive) is typical of most digital processing equipment currently in use as well as most legacy equipment utilizing modern memory modules. Note that digital processing node 410 has the same configuration as node 400 comprising a digital processing unit 411, a memory configuration bus 412, a local memory bus 413, and memory connection devices 414, 415, and 416. Also Note that digital processing node 420 has the same configuration as node 400 comprising a digital processing unit 421, a memory configuration bus 422, a local memory bus 423, and memory connection devices 424, 425, and 426. The only notable differences between digital processing nodes 400, 410, and 420 are the devices that populate memory connection devices 404, 405, 506, 414, 415, 516, 424, 425, and 426 as discussed in the following paragraphs. These differences are illustrated to show the flexibility of configuring the invention and are not necessarily a requirement of the invention.

Memory connection device 404 on digital processing node 400 is shown populated with a memory module 407, which is private memory in the sense that this physical memory cannot be shared by other digital processing nodes. Memory connection devices 405 and 406 are populated by memory network interfaces 100 and 101 respectively. Memory network interface 100 is connected to memory network hub 274 by network connection 300. In a similar fashion, memory network interface 101 is connected to memory network hub 274 by network connection 310.

Memory connection device 414 on digital processing node 410 is populated with memory module 417, which functions as private memory. Memory connection device 415 is populated with a memory network interface 102, which is connected to memory network hub 274 by network connection 320. In this example, memory connection device 416 is unpopulated.

Memory connection devices 424, 425, and 426 on digital processing node 420 are populated by memory network interfaces 103, 104, and 105 respectively, which in turn are connected to memory network hub 274 by network connections 330, 340, and 350 respectively.

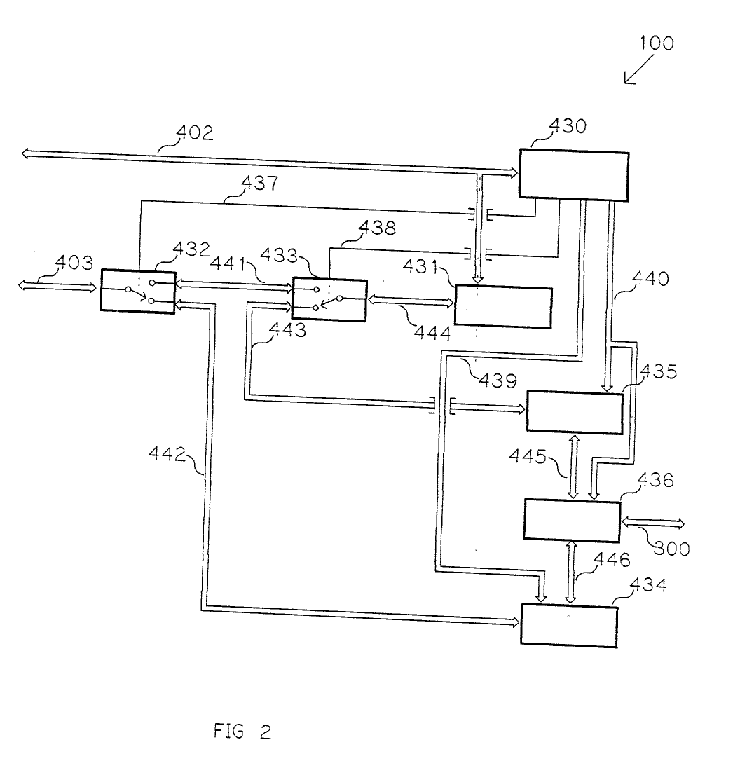

Refer to FIG. 2, which details memory network interface 100, and is typical of memory network interfaces 101, 102, 103, 104, and 105. Memory configuration bus 402 is connected to memory module 431, which is similar in form and function to memory modules 407 and 417 illustrated in FIG. 1. Memory configuration bus 402 allows access to memory configuration information stored in nonvolatile memory on said memory module. In addition, memory configuration bus 402 is also connected to interface configuration controller 430. Interface configuration controller 430 provides a local memory bus control signal 437 to local memory bus switch 432, a memory module bus control signal 438 to memory module bus switch 433, an inbound network address signal 440 to inbound address translator 435 and network transceiver 436, and an outbound translation address 439 to outbound address translator 434.

Memory read and memory write request are presented to the interface on local memory bus 403 and routed through local memory bus switch 432, which connects the bus to memory bus switch 433 via crossover bus 441, or to outbound address translator 434 via outbound bus connections 442 depending on the state of local memory bus control signal 437. Memory module bus switch 433 routes crossover bus 441 or inbound memory bus 444 from inbound address translator 435 to memory module 431 via memory bus 444 depending on the state of memory module bus control signal 438.

When both local memory bus switch 432 and memory module bus switch 433 route bus signals via crossover bus 441, then memory module 431 is logically connected directly to local memory bus 402 and memory module 431 is logically treated as private memory; that is, both the memory module 431 and local memory bus 403 are disconnected from the network portion of the interface.

When local memory bus switch 432 routes local memory bus 402 to outbound address translator 434 via outbound memory bus 442, then outbound address translator 434 converts the local memory address to a network memory address and connects the translated request to memory network transceiver 436 via outbound request connection 446. The memory network transceiver 436 transmits the request to the memory network via network connection 300. In the case of a read request, network transceiver 436 will wait for returned data from network connection 300, then pass the returned data to local bus 403 via outbound request connection 446, outbound address translator 434, outbound memory bus 442, and local memory bus switch 432.

When memory module switch 433 is configured to route memory module bus 444 to inbound memory bus 443, then memory module 431 can be accessed from the network. In this case, memory requests are received from the network connection 300 by network transceiver 436, which forwards the request to inbound address translator 435 via inbound request connection 445. Inbound address translator 435 converts the network address to a local address, then forwards the request to memory module 431 via inbound memory bus 443, memory module bus switch 433,, and memory module bus 444. In the case of read requests, data read from memory module 431 is routed via memory module bus 444, memory module bus switch 433, inbound memory bus 443, inbound address translator 435, inbound request connection 445 to memory network transceiver 436, which transmits the reply to the network via network connection 300.

In cases where an outbound request is made to the same network address as that configured in network transceiver 436, then network address transceiver 436 forwards the request directly to the inbound request connection 445 without sending the request out network connection 300. In these cases memory network transceiver 300 also provides arbitration for simultaneous requests from the local bus (403) and the memory network connection (300).

Therefore, the memory network interface 100 described above can either access memory in the interface or access memory elsewhere on the memory network depending on the specific request and configuration information presented to configuration controller 430. This creates what can be considered as a virtual memory system distributed over many processing nodes. As such, once a processing node stores data in the virtual memory, it is instantly available to all other processing nodes that are configured to access the corresponding network memory address. That is, none of the processing nodes needs to make a network request (or manage data transfer) for information in collective memory network; as far as software is concerned, the information is already available in memory.

Because memory access rates can often exceed 100 million requests per second, the network media chosen should also be of similar or greater speed. Such rates are easily achieved with fiber optics or LVD techniques. If a network media is chosen to be significantly faster than the local memory bus bandwidth, then access to memory located at another node will be accessible at the local access rate, less any propagation delay introduced by long network connections. The result is what appears to be a nearly instantaneous appearance of data at all shared nodes when any one node writes data into shared memory.

Note that because memory network transceiver 436 forwards outbound requests from outbound request connection 446 directly to inbound request connection 445 for cases where the outbound memory network address is the same as the memory network address configured in transceiver 436, the memory network interface can be simplified by removing local bus switch 432, crossover bus 441, memory module bus switch 433, local bus switch control signal 437, and memory module bus switch control signal 438.

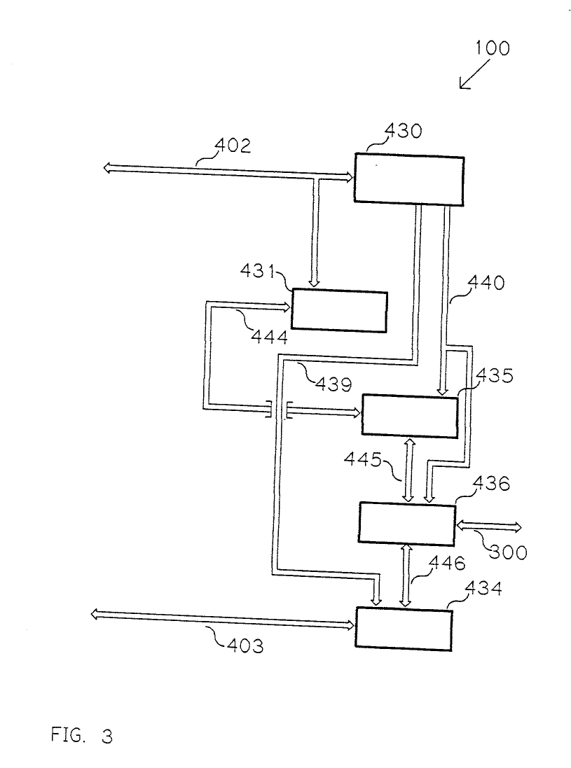

The simplified memory network interface is shown in FIG. 3. The configuration of this circuit is similar to that of FIG. 2 with a few exceptions (in addition to the deletions described above); local memory bus 403 is connected directly to outbound address translator 434 (in lieu of outbound memory bus 442), and memory module bus 444 is connected directly to inbound address translator 444 (in lieu of inbound memory bus 443).

In this configuration, all outbound requests are routed from local memory bus 403 directly to outbound address translator 434, and all inbound requests are routed from inbound address translator 435 directly to memory module bus 444; the remainder of the circuit operates identically to the circuit in FIG. 2. The main difference is that in order to configure memory module 431 as private memory, the outbound translation address configured into outbound address translator 434 must be identical to the memory network interface address configured into memory network transceiver 436; this will cause requested from local memory bus 403 to be through outbound address translator 434, outbound request connection 446, memory network transceiver 436, inbound request connection 445, inbound address translator 435 to memory module 431 via memory module bus 444. While this technique eliminates the cost of crossover bus 441 and the switches connected to that bus (432 and 433), it come with a slight performance cost in terms of translation and gate delays when the interface is configured to use memory module 431 as private memory.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A shared memory network system for nearly instance sharing of data comprising, in combination:
a plurality of digital processing nodes wherein each of the digital processing nodes may access internal memory within the digital processing node or memory elsewhere within the memory network system wherein each of the plurality of digital processing nodes comprises:
a processor which provides memory request signals and memory configuration signals;
a memory configuration bus coupled to the processor to access memory configuration data;
a local memory bus coupled to the processor;
a plurality of memory connection devices coupled to the memory configuration bus and the local memory bus;
a memory module coupled to at least one of the plurality of memory connection devices;
a memory network interface coupled to at least one of the plurality of memory connection devices; and
a memory network hub coupled to the memory network interface.

2. The shared memory network system in accordance with claim 1 wherein each of the of memory network interfaces comprises:
a memory storage device coupled to the memory configuration bus;
an interface configuration controller coupled to the memory configuration bus;
a network transceiver coupled to the interface configuration controller; and
address translators coupled to the interface configuration controller.

3. The shared memory network system in accordance with claim 1 wherein the address translators comprises:
a first address translator connecting the network transceiver to the local memory bus; and
a second address translator connecting the network transceiver to the memory storage device.

4. The shared memory network system in accordance with claim 3 wherein the memory network interface further comprises:
a crossover bus; and
switching devices coupled to the local memory bus.

5. The shared memory network system in accordance with claim 4 wherein the switching devices comprises:
a first bus switch connecting the local memory bus to the crossover bus and the first address translator; and
a second bus switch connecting the memory storage device to the crossover bus and the second address translator.
